(19) United States
(12) Patent Application Publication
(10) Pub. No.: US 2007/0107632 A1
(43) Pub. Date: May 17, 2007

(54) Pigmented wall and ceiling spackle

(76) Inventor: Richard L. Ball, Delaware, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/589,443

(22) Filed: Oct. 30, 2006

Related U.S. Application Data
(60) Provisional application No. 60/731,442, filed on Oct. 28, 2005.

(51) Int. Cl. C08K 5/00

(52) U.S. Cl. 106/287.24; 524/291

(57) ABSTRACT

A wall or other dwelling surface defect repair compound that is pigmented a color that makes it readily distinguishable from the solid surface by its contrasting color. The pigmentation can be a conventional universal latex paint tint, and the compound can be joint compound. By mixing the tint into the joint compound, a colored paste-like mixture results that can be spread over the defect in the wall. Upon hardening, the pigmented mixture is easily seen by a worker who sands the mixture to match the wall's contour, and then primes and/or paints the wall and the mixture. By tinting the compound a color that is distinguishable from the wall's color, the worker can easily find all regions of the wall that require sanding and/or priming prior to painting.

### BACKGROUND OF THE INVENTION

1. Field of the Invention

This invention relates generally to spackle used as a patch, for example for drywall and plaster walls and ceilings, and more specifically relates to a pigmented spackle for making the spackled regions visible to the human eye.

2. Description of the Related Art

Conventional paste wall and ceiling repair products, such as plaster of Paris, joint compound, vinyl spackle and other materials used to patch holes and cracks in walls, ceilings and other surfaces, are colored white or off-white. These paste materials are spread, typically using a spatula, trowel or knife, in and around a hole, thereby filling the hole by bridging the material from one solid surface to another. The paste material hardens by curing or drying, is sanded to match the surface contour, and is then painted to protect the spackle and to make the spackled match the underlying surface.

Walls and ceilings in homes are typically painted in lighter colors, such as tan and white, which is the same color as most cured paste spackles. This similarity in colors makes it difficult to locate spackled regions on a wall once the spackle has dried. If applied correctly, the spackle thus blends into the wall, thereby making it difficult to see so that one can determine whether sanding of the dried spackling is finished, and, if so, which areas of the wall need to be coated with a priming paint. In order to locate the areas to be sanded and primed, a user typically must shine a light on the wall at an angle to create shadows and illuminate the differently textured materials, because the similarly-colored wall and spackling are not readily distinguished otherwise. This is often necessary in conditions where there is little to no lighting available, and can be difficult and time-consuming. Additionally, conventional spackle can be used on bare drywall or between coats of paint. If oil paints or enamels are used, a special primer, such as an alcohol-based primer, is needed.

It is known to add food coloring to a spackling in order to assist the user in seeing where the spackle is located on the wall. However, food coloring does not mix properly with the chemical compounds of the spackle and will bleed into the surrounding wall area. In addition, food coloring will bleed through a latex primer coat, requiring the user to use an alcohol-based primer that will sometimes make “shiny” spots on the wall after drying. Furthermore, it is unknown whether such a method of adding food coloring to spackle was known or used prior to the invention by Applicant.

It is an object and feature of the invention to provide an improved colored spackle that retains its pigment even after drying, and that will not significantly transfer pigmentation into a primer paint or cause bleeding through the top coat of a self-priming latex paint.

### BRIEF SUMMARY OF THE INVENTION

The invention is a method of repairing a defect in a solid surface, such as a wall, having a first color. The method comprises mixing a compound that hardens upon curing, such as joint compound, with a pigment component, such as universal latex paint tint. This thereby gives the compound a second color that is readily distinguished by the unaided human eye from the first color at least after the compound has cured. The method also includes the step of spreading the mixture on the solid surface at the location of the defect and waiting for the mixture to cure. The method also includes the step of viewing the mixture on the wall and distinguishing the second color from the first color.

In a preferred embodiment of the invention, the hardened mixture is mechanically abraded on the wall to conform the mixture to a surface contour and then painted In a most preferred embodiment, the pigment component is selected to contrast wth the first color so that it can be easily distinguished by the naked human eye.

The invention also contemplates a material for repairing a defect in a solid surface having a first color. The material comprises a compound that hardens upon curing, such as joint compound, and a pigment component. The pigment component is mixed with the joint compound to give the mixture a second color that is readily distinguished by the aided human eye from the first color at least after the mixture has cured. The pigment component is preferably a universal latex paint tint.

### BRIEF DESCRIPTION OF THE SEVERAL VIEWS OF THE DRAWINGS

FIG. 1 is a side view in section illustrating a wall with a hole.

FIG. 2 is a side view in section illustrating the wall of FIG. 1 with spackle spread into the hole.

FIG. 3 is a side view in section illustrating the wall of FIG. 1 with the spackle sanded to match the contour of the wall.

FIG. 4 is a view in perspective illustrating the wall of FIG. 1.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

The invention is a pigmented spackle used to cover holes and imperfections in a dwelling finish surface, such as a wall or ceiling, and the spackle has a pigmentation included in it that maintains its color after the spackle dries, thereby making the spackle easily noticed on a wall or ceiling. The spackle can be joint compound, toppings, vinyl-based spackles or any variety of hardening paste or paste-like materials that are placed on a wall or ceiling, sanded and then painted. Of course, the pigmented material can be used on any finish surface of a dwelling where patches are desired, including, but not limited to, floors and exterior walls.

Conventional spackle has a paste consistency, similar to peanut butter, making it easy to add pigmentation by mechanical mixing, and easy to spread over a wall or other solid surface using conventional wall repair tools, such as a spatula or trowel. A universal latex paint tint similar to that used for paints, such as PRISM® brand red 1334, can be used to tint joint compound to form the tinted spackle of the invention. It will be appreciated by the person of ordinary skill that there are numerous other colors and brands of universal tint that can be used instead of PRISM® brand red 1334. For example, the spackle can be pigmented green, blue, yellow, purple, orange or any other color that makes the spackle noticeable on the underlying surface color. A person having ordinary skill in the art will recognize that virtually any color can be used to pigment the spackle, and the above are only examples of some colors.

It is a critical feature of the invention that the spackle be tinted a color that contrasts with the wall color to render the spackle easily seen by the human eye. Therefore, if the wall is white, the spackle should be tinted a color that is easily seen against a white background, such as red or dark gray. Likewise, if the wall is red, the spackle should be tinted a different color, such as blue or dark gray, not red.

A universal tint chemically mixes with the base of the spackle compound so that the color will not break down during or after application, nor cause the spackle areas to bleed into the existing paint. Additionally, the universal tint is easily covered with latex or other primer and paint after sanding, and the tint will not leave noticeable spots on the walls where the spackle was used, because universal tint does not bleed through a subsequently applied coat of paint.

To make a tinted spackle, a user begins by selecting the amount of spackle desired, which can be the amount needed for a particular wall, room or building. For example, one quart can be used for repair work in an average room. The user selects the color of the universal tint desired for the color of the wall or walls, such as red for white walls. About three quarters of a teaspoon of tint is then added to the quart of spackle and the spackle and tint are mixed together thoroughly by mechanical means, such as a stir stick, rotary drill with paddle, screw driver, hand or any other suitable stirring device. The amount of tint can be adjusted according to preference. For example, for a darker color, more tint is used. It is possible to prepare the tinted spackle in larger quantities well before it is to be used. However, if a person will use a powdered spackle compound, the user should first mix the spackle with water to gain the paste-like consistency, and then add the tint. Once the tint is mixed into the spackle, the spackle is ready to be used in the conventional manner, such as by spreading using a spatula, knife or trowel.

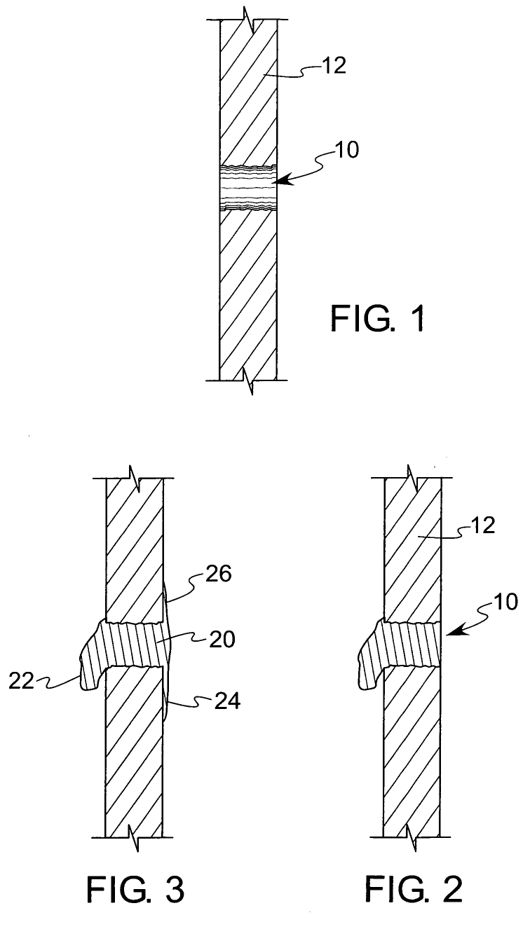

The illustration of FIG. 1 shows a hole 10 in a conventional gypsum sheet wall 12, otherwise referred to as “drywall” or “wallboard”. In the embodiment of FIG. 1, the wall's exterior is colored white, and the paste repair material, such as joint compound, is tinted red. In accordance with the invention, the hole 10 is filled with the tinted joint compound 20 as shown in FIG. 2. The compound 20 is forced into the hole 10 from one side, causing it to ooze out the opposite side to form a protuberance 22, which cannot ordinarily be seen from the side on which the repair is being made. For example, the wall 10 may be a sheet of drywall on one side of a bathroom wall, and the opposite side on which the protuberance 22 forms is in a space inside the wall behind another sheet of drywall.

The compound 20 is mounded up away from the wall 12 to form tapered regions 24 and 26, which are sheets of compound that are locally thinner at the edges than the hole 10 from which they emanate radially outwardly. These tapered regions cause the compound 20 at the hole 10 to be mounded, thereby accommodating any shrinkage of the compound during drying, and any imperfections surrounding the edge of the hole 10. Thus, after drying, the compound can be sanded or otherwise abraded to be flush with the surface of the wall 12, as shown in FIG. 3.

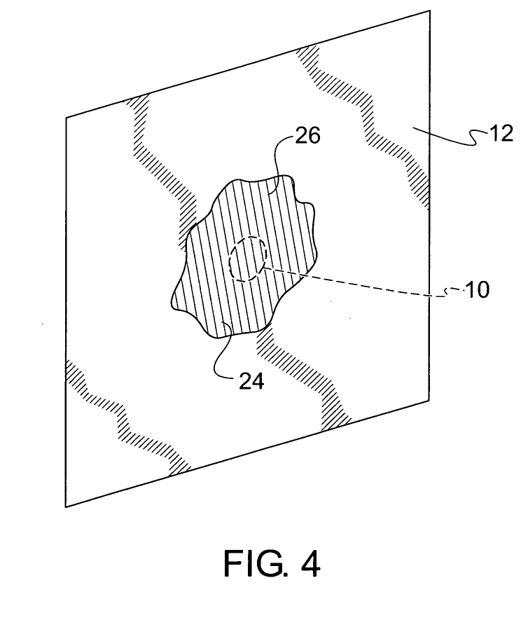

In FIG. 4, the hole 10 is shown in phantom, because it would not be visible through the compound generally, and the tapered regions 24 and 26 particularly. The tapered regions 24 and 26 have been sanded to a very thin dimension, and may appear to have essentially no thickness. However, the tapered regions 24 and 26 provide enough color, due to the fact that the pigmented compound 20 will fill in even small imperfections surrounding the hole 10, to be seen by the human eye. This is especially so when the color of the compound is chosen to stand out from the color of the wall 12.

The compound 20 has the contrasting color when being applied to the wall and retains the color when dried. It is possible that the compound may dry slightly darker or lighter than when it has a paste consistency. However, the compound remains visible against the background. Once sanded and dried, the compound 20 is primed, if necessary, and then painted along with the remainder of the wall 12. The colored paint hides the tinted compound 20 beneath it so that the compound 20 is no longer visible to the human eye. Because the tinting material is chosen deliberately, no bleeding into this final coat will occur.

In summary, therefore, by tinting the spackle and making it easily noticed during the repair stage, one can determine where sanding and priming need to occur on the wall. Furthermore, one can determine whether the spackle has been sanded smooth with the underlying wall surface without rubbing a hand over the entire wall surface. After sanding, a latex primer or a self-priming quality latex paint can easily be painted over the spackled areas, thereby leaving a clean, smooth wall surface which the repaired area is not readily noticed.

This invention is advantageous over previous methods because the user can distinguish the tinted spackled areas from the underlying wall at one time, thereby making sanding the spackle much easier and making the work more efficient. Furthermore, the tint does not bleed onto the surrounding surfaces or into the paint when painted over thereby eliminating the feature that would be undesirable when the repair is complete, if it remained uncovered.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A material for repairing a defect in a dwelling finish surface having a first color, the material comprising a compound that hardens upon curing and a pigment component mixed with the compound to give the mixture a second color that is readily distinguished by the unaided human eye from the first color at least after the mixture has cured.

2. The material in accordance with claim 1, wherein the compound further comprises joint compound.

3. The material in accordance with claim 1, wherein the compound further comprises plaster.

4. The material in accordance with claim 1, wherein the compound further comprises vinyl spackle.

5. The material in accordance with claim 2, wherein the pigment component further comprises a universal latex paint tint.

6. A method of repairing a defect in a dwelling finish surface having a first color, the method comprising:
a. mixing a compound that hardens upon curing with a pigment component, thereby giving the compound a second color that is readily distinguished by the unaided human eye from the first color at least after the compound has cured;
b. spreading the mixture on the surface at the location of the defect;
c. waiting for the mixture to cure; and
d. viewing the mixture on the surface and distinguishing the second color from the first color.

7. The method in accordance with claim 6, further comprising:
a. mechanically abrading the hardened mixture on the surface to conform the mixture to a surface contour; and
b. painting the surface and the mixture.

8. The method in accordance with claim 7, further comprising selecting the pigment component to contrast with the first color.
